(19) United States
(12) Patent Application Publication
(10) Pub. No.: US 2022/0104320 A1
(43) Pub. Date: Mar. 31, 2022

(54) LIGHTING APPARATUS

(71) Applicant: XIAMEN ECO LIGHTING CO. LTD., Xiamen (CN)

(72) Inventors: Hongkui Jiang, Xiamen (CN); Yinglong Chen, Xiamen (CN); Chunhua Wang, Xiamen (CN)

(21) Appl. No.: 17/486,233

(22) Filed: Sep. 27, 2021

(30) Foreign Application Priority Data
Sep. 27, 2020 (CN) 202022159060.1

(51) Int. Cl. H05B 45/20; H05B 47/19; F21V 14/06; H05B 45/10; H05B 47/115

(52) U.S. Cl. CPC H05B 45/20; H05B 47/19; F21Y 2115/10; H05B 45/10; H05B 47/115; F21V 14/06

(57) ABSTRACT

A lighting apparatus includes a light source plate, a first set of LED modules, a second set of LED modules, a wireless module and a driver. The first set of LED modules are disposed on an inner area of the light source plate. The second set of LED modules are disposed on an exterior area of the light source plate. The exterior area surrounds the inner area. The wireless module receives an external command indicating a spreading angle of an output light. The driver selectively turns on the first set of LED modules or turns on the second set of LED modules according to external command received by the wireless module to generate the output light of the indicated spreading angle.

### FIELD

The present invention is related to a lighting apparatus, and more particularly related to a lighting apparatus with a flexible configuration.

### BACKGROUND

The time when the darkness is being lighten up by the light, human have noticed the need of lighting up this planet. Light has become one of the necessities we live with through the day and the night. During the darkness after sunset, there is no natural light, and human have been finding ways to light up the darkness with artificial light. From a torch, candles to the light we have nowadays, the use of light have been changed through decades and the development of lighting continues on.

Early human found the control of fire which is a turning point of the human history. Fire provides light to bright up the darkness that have allowed human activities to continue into the darker and colder hour of the hour after sunset. Fire gives human beings the first form of light and heat to cook food, make tools, have heat to live through cold winter and lighting to see in the dark.

Lighting is now not to be limited just for providing the light we need, but it is also for setting up the mood and atmosphere being created for an area. Proper lighting for an area needs a good combination of daylight conditions and artificial lights. There are many ways to improve lighting in a better cost and energy saving. LED lighting, a solid-state lamp that uses light-emitting diodes as the source of light, is a solution when it comes to energy-efficient lighting. LED lighting provides lower cost, energy saving and longer life span.

The major use of the light emitting diodes is for illumination. The light emitting diodes is recently used in light bulb, light strip or light tube for a longer lifetime and a lower energy consumption of the light. The light emitting diodes shows a new type of illumination which brings more convenience to our lives. Nowadays, light emitting diode light may be often seen in the market with various forms and affordable prices.

After the invention of LEDs, the neon indicator and incandescent lamps are gradually replaced. However, the cost of initial commercial LEDs was extremely high, making them rare to be applied for practical use. Also, LEDs only illuminated red light at early stage. The brightness of the light only could be used as indicator for it was too dark to illuminate an area. Unlike modern LEDs which are bound in transparent plastic cases, LEDs in early stage were packed in metal cases.

In 1878, Thomas Edison tried to make a usable light bulb after experimenting different materials. In November 1879, Edison filed a patent for an electric lamp with a carbon filament and keep testing to find the perfect filament for his light bulb. The highest melting point of any chemical element, tungsten, was known by Edison to be an excellent material for light bulb filaments, but the machinery needed to produce super-fine tungsten wire was not available in the late 19th century. Tungsten is still the primary material used in incandescent bulb filaments today.

Early candles were made in China in about 200 BC from whale fat and rice paper wick. They were made from other materials through time, like tallow, spermaceti, colza oil and beeswax until the discovery of paraffin wax which made production of candles cheap and affordable to everyone. Wick was also improved over time that made from paper, cotton, hemp and flax with different times and ways of burning. Although not a major light source now, candles are still here as decorative items and a light source in emergency situations. They are used for celebrations such as birthdays, religious rituals, for making atmosphere and as a decor.

Illumination has been improved throughout the times. Even now, the lighting device we used today are still being improved. From the illumination of the sun to the time when human can control fire for providing illumination which changed human history, we have been improving the lighting source for a better efficiency and sense. From the invention of candle, gas lamp, electric carbon arc lamp, kerosene lamp, light bulb, fluorescent lamp to LED lamp, the improvement of illumination shows the necessity of light in human lives.

There are various types of lighting apparatuses. When cost and light efficiency of LED have shown great effect compared with traditional lighting devices, people look for even better light output. It is important to recognize factors that can bring more satisfaction and light quality and flexibility.

People expect to have more control over light devices. Sometimes they may use remote controls or just mobile phones with corresponding apps.

However, if the structure is too complicated, the manufacturing cost is increased. Therefore, it is important to provide a simple design with flexible configuration. People expect to have more control over light devices. Sometimes they may use remote controls or just mobile phones with corresponding apps.

However, if the structure is too complicated, the manufacturing cost is increased. Therefore, it is important to provide a simple design with flexible configuration. People expect to have more control over light devices. Sometimes they may use remote controls or just mobile phones with corresponding apps.

However, if the structure is too complicated, the manufacturing cost is increased. Therefore, it is important to provide a simple design with flexible configuration. People expect to have more control over light devices. Sometimes they may use remote controls or just mobile phones with corresponding apps.

However, if the structure is too complicated, the manufacturing cost is increased. Therefore, it is important to provide a simple design with flexible configuration.

### SUMMARY

In some embodiments, a lighting apparatus includes a light source plate, a first set of LED modules, a second set of LED modules, a wireless module and a driver.

The first set of LED modules are disposed on an inner area of the light source plate.

The second set of LED modules are disposed on an exterior area of the light source plate.

The exterior area surrounds the inner area.

The wireless module receives an external command indicating a spreading angle of an output light.

The driver selectively turns on the first set of LED modules or turns on the second set of LED modules according to external command received by the wireless module to generate the output light of the indicated spreading angle.

In some embodiments, the lighting apparatus may also include a lens covering the first set of LED modules and the second set of LED modules.

In some embodiments, the lens has a first lens part for directing a first light of the first set of LED modules.

The lens has a second lens part for directing a second light of the second set of LED modules.

In some embodiments, the first lens part and the second lens part are made of different materials for changing different light parameters of the first light and the second light.

In some embodiments, the light parameter includes a color.

In some embodiments, the light parameter includes a color temperature.

In some embodiments, at least one of the first lens part and the second lens part includes a fluorescent material.

In some embodiments, the first lens part and the second lens part comprise different fluorescent materials.

In some embodiments, the first set of LED modules and the second set of LED modules comprise same LED chips.

In some embodiments, the first light from the first lens part forms a light beam.

The second light from the second lens part forms a diffused light.

In some embodiments, the lighting apparatus may also include a manual switch for configuring a color temperature of the output light.

In some embodiments, the first set of LED modules includes a first type of LED chip and a second type of LED chip.

The second set of LED modules include the first type of LED chip and the second type of LED chip.

The first type of LED chip and the second type of LED chip emit lights of different color temperatures.

In some embodiments, a first ratio between the first type of LED chip and the second type of LED chip disposed in the first set of LED modules is the same as a second ratio between the first type of LED chip and the second type of LED chip disposed in the second set of LED modules.

In some embodiments, the driver includes a constant current source for generating a constant current either to the first set of LED modules or the second set of LED modules.

In some embodiments, when the driver detects a failure of one of the first set of LED modules and the second set of LED modules, the other of the first set of LED modules and the second set of LED modules is automatically selected to turn on as a backup solution.

In some embodiments, the lighting apparatus may also include a motion sensor coupled to the driver for detecting an ambient motion.

The driver selectively turns on the first set of LED modules or the second set of LED modules according to the detected motion.

In some embodiments, the driver gradually changes light intensities of the first set of LED modules and the second set of LED modules for a transition.

In some embodiments, further includes a lens only covering the first set of LED modules.

In some embodiments, a second light of the second set of LED modules is diffused by a diffusion cover.

In some embodiments, the second set of LED modules are placed outside the lens, and a lens surface facing to the second set of LED modules has a reflective layer.

### BRIEF DESCRIPTION OF DRAWINGS

FIG. 1 illustrates a circuit structure of a lighting apparatus embodiment.

FIG. 2 illustrates a control system of the example in FIG. 1.

FIG. 3 illustrates a circuit example for implementing the lighting apparatus in FIG. 1.

FIG. 4 illustrates another circuit diagram for providing a circuit control.

FIG. 5 illustrates a light source arrangement.

FIG. 6 shows another lighting apparatus embodiment.

FIG. 7 shows another lighting apparatus embodiment.

### DETAILED DESCRIPTION

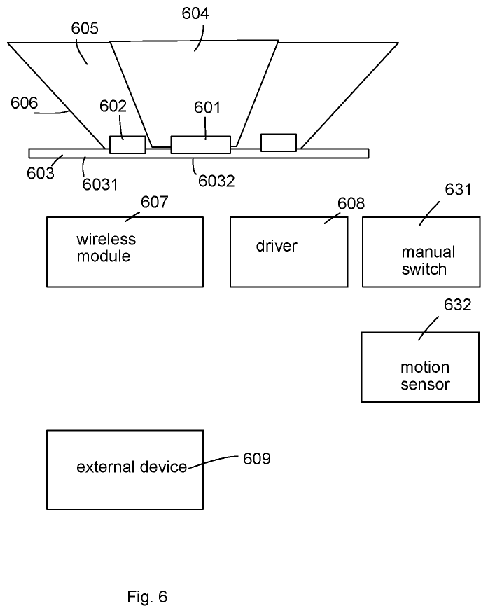

In FIG. 6, a lighting apparatus includes a light source plate 603, a first set of LED modules 601, a second set of LED modules 602, a wireless module 607 and a driver 608.

The first set of LED modules 601 are disposed on an inner area 6032 of the light source plate 603.

The second set of LED modules 602 are disposed on an exterior area 6031 of the light source plate 603.

The exterior area 6031 surrounds the inner area 6032.

The wireless module 607 receives an external command indicating a spreading angle of an output light from an external device 609. For example, the external device 609 is a remote control or a mobile phone loaded with a corresponding control app.

The external device 609 sends the external command to the wireless module 607. The driver 608 translates the external command to a set of corresponding control signals for controlling the first set of LED modules 601 and the second set of LED modules 602.

The driver 608 selectively turns on the first set of LED modules 601 or turns on the second set of LED modules 602 according to external command received by the wireless module 607 to generate the output light of the indicated spreading angle.

For example, the first light of the first set of LED modules has a spreading angle of 45 degrees. Specifically, most of the light of the first set of LED modules is narrowed in a range of 45 degrees from a central axis of the first set of LED modules. In contrast, the spreading angle of the light of the second set of LED modules may be 70 degrees.

Such design makes it easy to change a light spreading angle without use of a mechanic structure.

For example, the first set of LED modules may be disposed with a first tilt angles with respect to the light source plate while the second set of LED modules are disposed with a second tilt angles with respect to the light source plate so as to provide two different light spreading angles.

Another way to do so is explained as follows by using lens.

In FIG. 6, the lighting apparatus may also include a lens 606 covering the first set of LED modules 601 and the second set of LED modules 602.

In some embodiments, the lens 606 has a first lens part 604 for directing a first light of the first set of LED modules 601.

The lens 606 has a second lens part 605 for directing a second light of the second set of LED modules.

In some embodiments, the first lens part and the second lens part are made of different materials for changing different light parameters of the first light and the second light.

In some embodiments, the light parameter includes a color. For example, the first lens part 604 is mixed with a first color paint so as to render the first light of the first set of LED modules with a first color. The second lens part 605 may be mixed with a second color paint so as to render the second light of the second set of LED modules with a second color.

In some embodiments, the first light and the second light may be guided to form lights of similar spreading angles but different color or color temperatures.

In some embodiments, the light parameter includes a color temperature.

In some embodiments, at least one of the first lens part and the second lens part includes a fluorescent material. As known to persons of ordinary skilled in the art, light parameter like color temperature or colors may be adjusted by guiding light to pass through fluorescent materials. In such design fluorescent materials may be added to the lens or attached to a surface of the lens.

In some embodiments, the first lens part and the second lens part comprise different fluorescent materials.

In some embodiments, the first set of LED modules and the second set of LED modules comprise same LED chips. With different fluorescent materials attached to different light paths, even the same LED chips may render lights of different light parameters.

In FIG. 6, the first light from the first lens part 604 forms a light beam.

The second light from the second lens part 605 forms a diffused light.

In some embodiments, the lighting apparatus may also include a manual switch 631 for configuring a color temperature of the output light.

In some embodiments, the first set of LED modules includes a first type of LED chip and a second type of LED chip.

For example, FIG. 5 shows a light source plate disposed two circles of LED modules. The inner circle is disposed with the first set of LED modules 40. The outer circle is disposed with the second set of LED modules 30.

The first set of LED modules 40 has multiple LED chips, represented as circles. The multiple LED chips may include two types of LED chips with different light parameters, e.g. different color temperatures. The two types of LED chips are arranged in alternative order.

The second set of LED modules include the first type of LED chip and the second type of LED chip.

The first type of LED chip and the second type of LED chip emit lights of different color temperatures.

In some embodiments, a first ratio between the first type of LED chip and the second type of LED chip disposed in the first set of LED modules is the same as a second ratio between the first type of LED chip and the second type of LED chip disposed in the second set of LED modules. For example, the ratio of the first type of LED chips to the second type of LED chips in the first set of LED modules is 3:4. The ratio of the first type of LED chips to the second type of LED chips in the second set of LED modules is 3:4, the same as the first set of LED modules.

Such design makes the inner circle and the outer circle emitting lights of same color temperature with simple control.

In some embodiments, the driver includes a constant current source for generating a constant current either to the first set of LED modules or the second set of LED modules.

In such design, only one set of the first set of LED modules and the second set of LED modules is turned on each time. Therefore, the driver can be designed with a simple switch for determining supplying the same constant current to either the first set of LED modules or the second set of LED modules.

In some embodiments, when the driver detects a failure of one of the first set of LED modules and the second set of LED modules, the other of the first set of LED modules and the second set of LED modules is automatically selected to turn on as a backup solution. Such redundant design increases the life span of the overall light device.

The manual switch may be provided for users to choose a backup set of LED modules to fix the problem.

In some embodiments, the lighting apparatus may also include a motion sensor 632 coupled to the driver 608 for detecting an ambient motion, e.g. whether a person is sitting around the lighting apparatus, approaching the lighting apparatus or leaving the lighting apparatus.

The driver selectively turns on the first set of LED modules or the second set of LED modules according to the detected motion. When the spreading angles of the first set of LED modules and the second set of LED modules are different, the motion sensor 632 triggers a different spreading angle of output light.

For example, when a person is walking close to a painting, which is covered by the lighting apparatus, the light is getting more focused on the painting. When nobody is close to the painting, the light may be diffused for providing a general illumination.

In some embodiments, the driver gradually changes light intensities of the first set of LED modules and the second set of LED modules for a transition. For example, the first set of LED modules is increasing its light intensity gradually while the second set of LED modules is decreasing its light intensity gradually for a transition period.

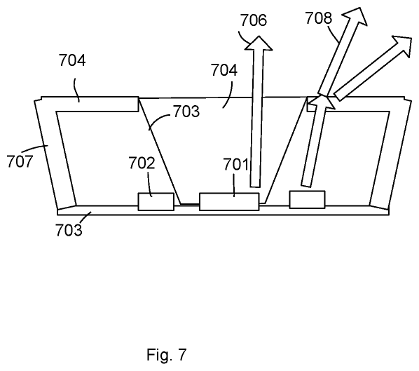

In FIG. 7, a lens 704 only covering the first set of LED modules 701.

In some embodiments, a second light of the second set of LED modules 702 is diffused by a diffusion cover 704. The diffusion 704 may extend to the lateral side 707 to provide a lateral light output too.

In some embodiments, the second set of LED modules 702 are placed outside the lens 704, and a lens surface 703 facing to the second set of LED modules 702 has a reflective layer.

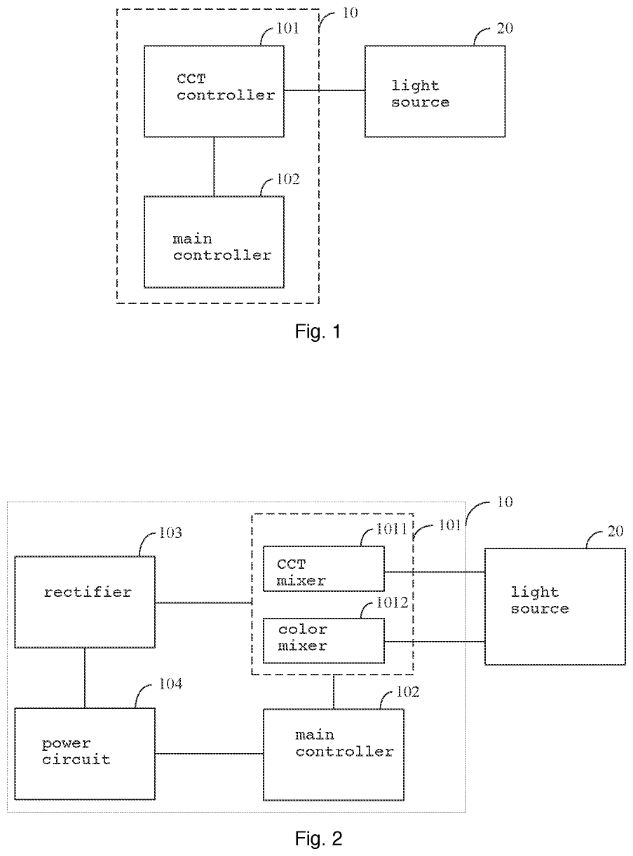

Please refer to FIG. 1, which shows another lighting apparatus embodiment.

In FIG. 1, the lighting apparatus includes a light source 20, a CCT (Color Temperature) controller 101 and a main controller 102. The main controller 102 receives a control command an translates the control command to control signals, e.g. PWM (Pulse Width Modulation) signals supplied to the CCT controller 101. The driver 101 integrates the CCT controller 101 and the main controller 102 for controlling the light source 20 to emit lights of different color temperatures.

Please refer to FIG. 2, which illustrates a more detailed example.

In FIG. 2, a rectifier 103 of the driver 10 converts an AC current source to a DC current source suppled to the CCT controller 101. The CCT controller 101 includes a CCT mixer 1011 and a color mixer 1012. In other words, not only mixed color temperatures may be produced, mixed color may also be produced with corresponding LED chips and their controls for generating mixed light parameters.

A power circuit 104 receives the DC power from the rectifier 103 and generates proper power to the main controller 102 for generating driving currents to the light source 20.

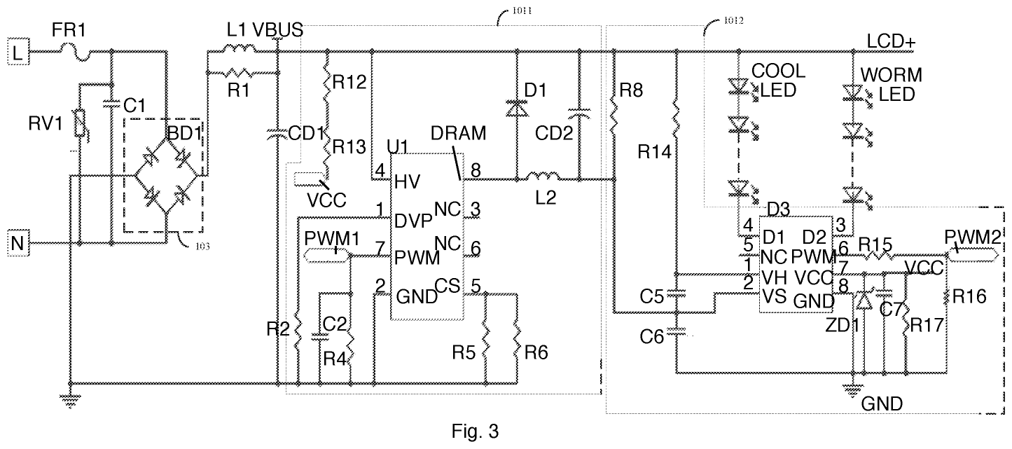

FIG. 3 shows an example circuit showing an example for implementing the CCT mixer 1011, the color mixer 1012, and rectifier 103.

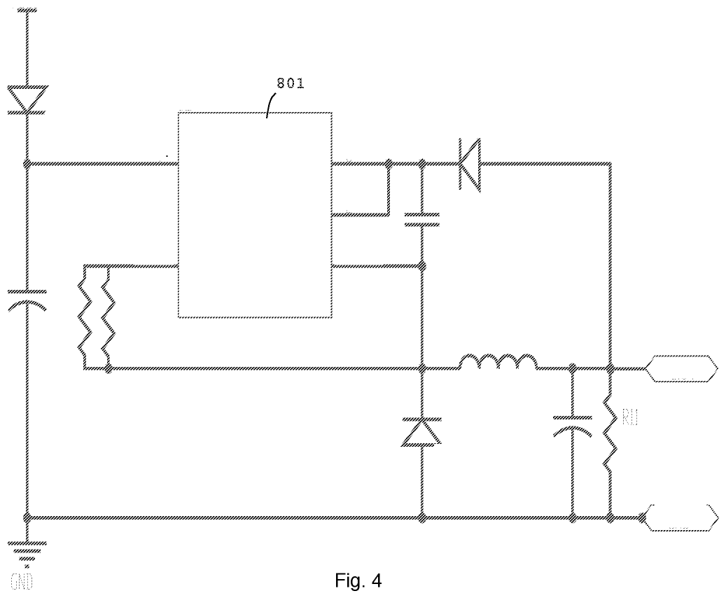

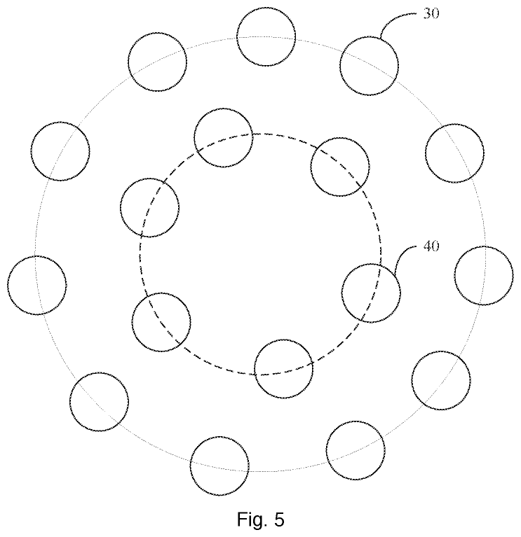

FIG. 4 shows an example circuit diagram of a control circuit 801 used in the example of FIG. 1 to FIG. 3.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings.

The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

1. A lighting apparatus, comprising:
a light source plate;
a first set of LED modules disposed on an inner area of the light source plate;
a second set of LED modules disposed on an exterior area of the light source plate, wherein the exterior area surrounds the inner area;
a wireless module for receiving an external command indicating a spreading angle of an output light; and
a driver for selectively turning on the first set of LED modules or turning on the second set of LED modules according to external command received by the wireless module to generate the output light of the indicated spreading angle.

2. The lighting apparatus of claim 1, further comprising a lens covering the first set of LED modules and the second set of LED modules.

3. The lighting apparatus of claim 2, wherein the lens has a first lens part for directing a first light of the first set of LED modules, wherein the lens has a second lens part for directing a second light of the second set of LED modules.

4. The lighting apparatus of claim 3, wherein the first lens part and the second lens part are made of different materials for changing different light parameters of the first light and the second light.

5. The lighting apparatus of claim 4, wherein the light parameter comprises a color.

6. The lighting apparatus of claim 4, wherein the light parameter comprises a color temperature.

7. The lighting apparatus of claim 6, wherein at least one of the first lens part and the second lens part comprises a fluorescent material.

8. The lighting apparatus of claim 7, wherein the first lens part and the second lens part comprise different fluorescent materials.

9. The lighting apparatus of claim 8, wherein the first set of LED modules and the second set of LED modules comprise same LED chips.

10. The lighting apparatus of claim 2, wherein the first light from the first lens part forms a light beam, wherein the second light from the second lens part forms a diffused light.

11. The lighting apparatus of claim 1, further comprising a manual switch for configuring a color temperature of the output light.

12. The lighting apparatus of claim 11, wherein the first set of LED modules includes a first type of LED chip and a second type of LED chip, wherein the second set of LED modules include the first type of LED chip and the second type of LED chip, wherein the first type of LED chip and the second type of LED chip emit lights of different color temperatures.

13. The lighting apparatus of claim 12, wherein a first ratio between the first type of LED chip and the second type of LED chip disposed in the first set of LED modules is the same as a second ratio between the first type of LED chip and the second type of LED chip disposed in the second set of LED modules.

14. The lighting apparatus of claim 13, wherein the driver comprises a constant current source for generating a constant current either to the first set of LED modules or the second set of LED modules.

15. The lighting apparatus of claim 1, wherein when the driver detects a failure of one of the first set of LED modules and the second set of LED modules, the other of the first set of LED modules and the second set of LED modules is automatically selected to turn on as a backup solution.

16. The lighting apparatus of claim 1, further comprising a motion sensor coupled to the driver for detecting an ambient motion, wherein the driver selectively turns on the first set of LED modules or the second set of LED modules according to the detected motion.

17. The lighting apparatus of claim 16, wherein the driver gradually changes light intensities of the first set of LED modules and the second set of LED modules for a transition.

18. The lighting apparatus of claim 1, further comprises a lens only covering the first set of LED modules.

19. The lighting apparatus of claim 18, wherein a second light of the second set of LED modules is diffused by a diffusion cover.

20. The lighting apparatus of claim 19, wherein the second set of LED modules are placed outside the lens, and a lens surface facing to the second set of LED modules has a reflective layer.
